(19) United States
(12) Patent Application Publication
(10) Pub. No.: US 2008/0292008 A1
(43) Pub. Date: Nov. 27, 2008

(54) Channel-Estimating Apparatus and Mimo Communication System

(75) Inventors: Jungi Kondo, Fukuoka (JP); Shouichi Koga, Fukuoka (JP); Yuji Igata, Fukuoka (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 10/575,359

(22) PCT Filed: Apr. 28, 2005
(86) PCT No.: PCT/JP2005/008576

§ 371 Date: Aug. 13, 2008

(30) Foreign Application Priority Data
May 7, 2004 (JP) 2004-138197

(51) Int. Cl. H04L 27/28

(52) U.S. Cl. 375/260

(57) ABSTRACT

A channel-estimating apparatus according to the present invention, including: an input unit (2) operable to receive several pieces of channel information (5) from a plurality of receivers (10), (11), in which the plurality of receivers (10), (11) are operable to perform MIMO communication through a plurality of channels; an estimating unit (3) operable to collectively estimate statuses of the plurality of channels in accordance with the several pieces of channel information (5) received by the input unit (2), whereby estimation results (6) are generated; and an output unit (4) operable to feed the estimation results (6) into the plurality of receivers (10), (11). As a result, interference from other pieces of MIMO communication-adapted communication equipment is suppressible, with consequential improvements in both of quality and capacity of communication.

### TECHNICAL FIELD

The present invention relates to an art operable to provide the improved quality and capacity of communication in spatial multiplexing communication and, in particular, multiple-input/multiple-output communication (hereinafter called MIMO communication).

### BACKGROUND ART

MIMO communication provides dramatically increased communication capacity in comparison with single antenna-to-single antenna or multiple antennas-to-single antenna communication.

The mechanism of the MIMO communication is disclosed in cited reference No. 1 (“On limits of wireless communications in fading environments when using multiple antennas”, G. J. Foschini and M. J. Gans, 1998 Wireless Personal Communications).

A multiple antennas-based communication system is disclosed in cited references No. 2 (published Japanese Patent Application Laid-Open No. 2000-101667) and No. 3 (published Japanese Patent Application Laid-Open No. 2001-237751).

According to the MIMO communication, each antenna can treat a narrow band signal, but a large number of narrow band signals received by a plurality of antennas are combined together in accordance with, e.g., the maximum ratio combining, with a consequential increase in communication capacity.

At this time, a MIMO communication receiver estimates channels, thereby calculating an optimal combination ratio in the maximum ratio combining.

However, there are cases where a MIMO communication system operable to perform MIMO communication through a certain frequency band is located adjacent to a different MIMO communication system operable to perform MIMO communication through the same frequency band as above. In this instance, as illustrated in FIG. 9, radio waves sent out from the latter MIMO communication system act as interference waves to the former MIMO communication system. This causes a problem that the interference waves degrade communication quality, with a concomitant problem of a reduction in communication capacity.

In particular, according to MIMO communication heretofore available, each receiver estimates channels, and consequently no estimation can be made as to channels formed between the contiguous MIMO communication systems. This causes another problem that the interference waves are non-suppressible, with ensuing reductions in both of the quality and capacity of communication.

FIG. 9 is a block diagram illustrating a prior art MIMO communication system.

A first MIMO communication set 100 includes a first transmitter 102 and a first receiver 103 to communicate with the first transmitter 102. Each of the first transmitter 102 and first receiver 103 includes a plurality of antennas to communicate. The communication through the plurality of antennas provides increased communication capacity.

The first receiver 103 includes a channel-estimating apparatus 110 operable to estimate a status of a channel between the first transmitter 102 and the first receiver 103. Results from the estimation are used as basic coefficients for use in weighting signals received by each of the antennas on the first receiver 103. The weighting coefficients allow each of the antennas to optimally receive the desired signals.

When a second MIMO communication set 101 is positioned adjacent to the first MIMO communication set 100, then the first receiver 103 is reached by transmitted radio waves 108, 109 from the second MIMO communication set 101 through a second transmitter 111. The transmitted radio waves from the second transmitter 111 act as interference waves to the first receiver 103. For example, the antenna 105 on the first receiver 103 is reached by the transmitted radio waves 108, 109 from the second transmitter 111 as well as transmitted radio waves 106, 107 from the first transmitter 102. In the MIMO communication, the transmitted radio waves 108, 109 are unexpected to reach the antenna 105. As a result, the channel-estimating apparatus 110 is impossible to estimate channels, through which the transmitted radio waves 108, 109 travel, and the influence of the transmitted radio waves 108, 109 is non-suppressible when the antenna 105 receives all signals.

Consequently, the transmitted radio waves 108, 109 act as interference waves, and the antenna 105 is thereby hindered from properly receiving all of the signals, with concomitant reductions in both quality and capacity of communication.

### DISCLOSURE OF THE INVENTION

In view of the above, an object of the present invention is to provide a channel-estimating apparatus and communication system, whereby the improved quality and capacity of communication are provided.

A first aspect of the present invention provides a channel-estimating apparatus including: an input unit operable to receive several pieces of channel information from a plurality of receivers that is operable to perform MIMO communication through a plurality of channels; an estimating unit operable to collectively estimate statuses of the plurality of channels in accordance with the several pieces of channel information received by the input unit, whereby estimation results are generated; and an output unit operable to feed the estimation results into the plurality of receivers.

The above system provides reduced interference between a pair of contiguous MIMO communication sets, with consequential improvements in both quality and capacity of communication.

A second aspect of the present invention provides a channel-estimating apparatus in which each of the plurality of receivers includes a plurality of antennas and a plurality of receiving units, each of which is connected to corresponding one of the plurality of antennas. In the present channel-estimating apparatus, each of the several pieces of channel information is received electrical power of a signal received by each of the plurality of receiving units.

The above system uses the received electrical power to estimates the channels, and statuses of the channels are thereby estimated with ease and accuracy.

A third aspect of the present invention provides a channel-estimating apparatus in which the estimating unit divides the received electrical power by each predetermined electrical power value, thereby generating the estimation results.

The above system allows for easy channel estimation.

A fourth aspect of the present invention provides a channel-estimating apparatus in which the estimating unit generates the estimation results for all of the plurality of channels.

The above system estimates all of the channels formed by the MIMO communication receivers, and estimation results provided thereby are used by the receivers. As a result, interference from a different adjacent MIMO communication set is reduced to provide the improved quality and capacity of communication.

A fifth aspect of the present invention provides a channel-estimating apparatus in which the estimation results are a combination of as many pieces of estimation results as the plurality of channels.

The above system allows each of the MIMO communication receivers to optimally receive signals in accordance with results from the estimation of all of the formed channels.

A sixth aspect of the present invention provides a channel-estimating apparatus in which each of the plurality of receiving units possesses weighting coefficients for use in weighting the received electrical power. In the present channel-estimating apparatus, the estimating unit generates coefficients as the estimation results. The coefficients correspond to the weighting coefficients.

The above system allows each of the MIMO communication receivers to weight the received signals in accordance with the channel estimation results. Consequently, the signals are receivable in accordance with statuses of the plurality of the formed channels. The estimation results are easily usable by each of the receivers to receive the signals with improved accuracy.

A seventh aspect of the present invention provides a channel-estimating apparatus in which the output unit feeds a coefficient set into the plurality of receivers. The coefficient set includes the coefficients.

The above system allows each of the receivers to make easy and proper use of the channel estimation results.

An eighth aspect of the present invention provides a channel-estimating apparatus in which the coefficients in the coefficient set correspond in number to all of the plurality of antennas possessed by the plurality of receivers.

The above system allows the estimation results to be directly used by each of the receivers to weight signals received by each of the receivers. As a result, statuses of the channels are reflected when the signals received by each of the receivers are weighted, with a consequential reduction in interference.

A ninth aspect of the present invention provides MIMO communication-adapted communication equipment, including: an input unit operable to receive several pieces of channel information from a plurality of receivers that is operable to perform MIMO communication through a plurality of channels; an estimating unit operable to collectively estimate statuses of the plurality of channels in accordance with the several pieces of channel information received by the input unit, whereby estimation results are generated; and an output unit operable to feed the estimation results into the plurality of receivers.

The above system provides reduced interference between a pair of contiguous MIMO communication sets, with consequential improvements in both quality and capacity of communication. Since the communication equipment is provided with the channel-estimating capability, a communication system is constructed with ease.

A tenth aspect of the present invention provides a communication system including: a plurality of receivers operable to provide MIMO communication through a plurality of channels; and a channel-estimating apparatus operable to estimate statuses of the plurality of channels. The channel-estimating apparatus includes: an input unit operable to receive several pieces of channel information from the plurality of receivers; an estimating unit operable to collectively estimate statuses of the plurality of channels in accordance with the several pieces of channel information received by the input unit, whereby estimation results are generated; and an output unit operable to feed the estimation results into the plurality of receivers.

The above system provides reduced interference between a pair of contiguous MIMO communication sets, with consequential improvements in both quality and capacity of communication.

An eleventh aspect of the present invention provides a communication system in which each of the plurality of receivers includes a plurality of antennas and a plurality of receiving units, each of which is connected to corresponding one of the plurality of antennas. In the present communication system, each of the several pieces of channel information is received electrical power of a signal received by each of the plurality of receiving units.

The above system uses the received electrical power to estimates the channels, and statuses of the channels are thereby estimated with ease and accuracy.

A twelfth aspect of the present invention provides a communication system in which the estimating unit divides the received electrical power by each predetermined electrical power value, thereby generating the estimation results.

The above system allows for easy channel estimation.

A thirteenth aspect of the present invention provides a communication system in which the estimating unit generates the estimation results for all of the plurality of channels.

The above system estimates all of the channels formed by the MIMO communication receivers, and estimation results provided thereby are used by the receivers. As a result, interference from a different adjacent MIMO communication set is reduced to provide the improved quality and capacity of communication.

A fourteenth aspect of the present invention provides a communication system in which the estimation results are a combination of as many pieces of estimation results as the plurality of channels.

The above system allows each of the MIMO communication receivers to optimally receive signals in accordance with results from the estimation of all of the formed channels.

A fifteenth aspect of the present invention provides a communication system in which each of the plurality of receiving units possesses weighting coefficients for use in weighting the received electrical power. In the present communication system, the estimating unit generates coefficients as the estimation results. The coefficients correspond to the weighting coefficients.

The above system allows each of the MIMO communication receivers to weight the received signals in accordance with the channel estimation results. As a result, the signals are receivable in accordance with statuses of the plurality of channels. The estimation results are easily usable by each of the receivers to receive the signals with improved accuracy.

A sixteenth aspect of the present invention provides a communication system in which the output unit feeds a coefficient set into the plurality of receivers. The coefficient set includes the coefficients.

The above system allows each of the receivers to make easy and proper use of the channel estimation results.

A seventeenth aspect of the present invention provides a communication system in which the coefficients in the coefficient set correspond in number to all of the plurality of antennas possessed by the plurality of receivers.

The above system allows the estimation results to be directly used by each of the receivers to weight signals received by each of the receivers. As a result, statuses of the channels are reflected when the signals received by each of the receivers are weighted, with a consequential reduction in interference.

An eighteenth aspect of the present invention provides a communication system in which the MIMO communication is made through antennas possessed by at least two receivers among the plurality of receivers.

The above system provides a MIMO communication system in which unused antennas in the MIMO communication are operatively utilized. As a result, a flexible communication system is achievable.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating a channel-estimating apparatus according to a first embodiment of the present invention;

FIG. 2 is a block diagram illustrating a communication system according to the first embodiment;

FIG. 3 is a block diagram illustrating the communication system according to the first embodiment;

FIG. 4 is a block diagram illustrating the communication system according to the first embodiment;

FIG. 5 is a block diagram illustrating a plurality of receivers according to the first embodiment;

FIG. 6 is a block diagram illustrating the plurality of receivers according to the first embodiment;

FIG. 7 is a block diagram illustrating a communication system according to a second embodiment;

FIG. 8 is a block diagram illustrating a communication system according to a third embodiment; and

FIG. 9 is a block diagram illustrating a prior art MIMO communication system.

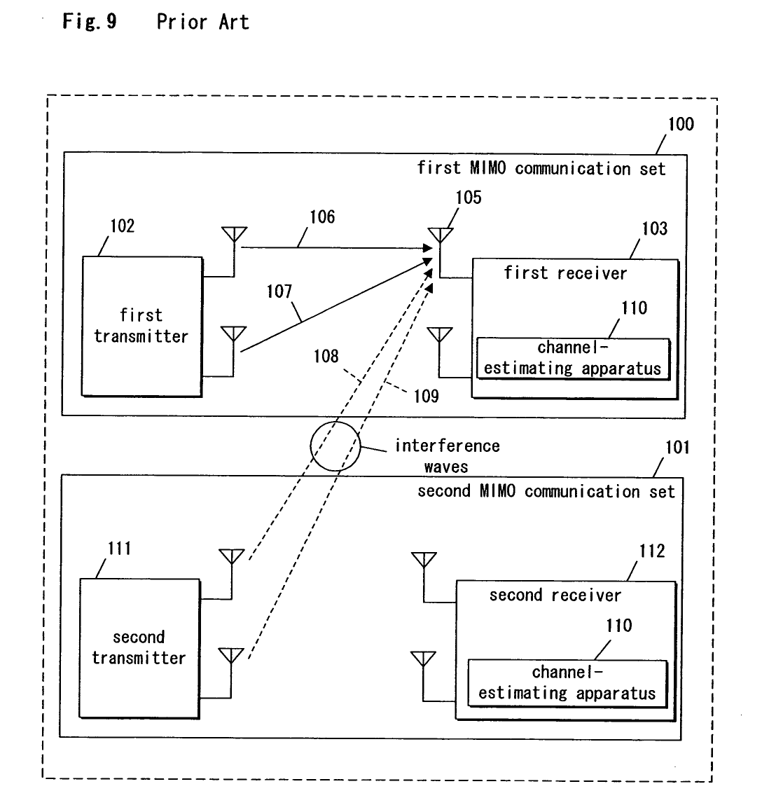

### BEST MODE FOR CARRYING OUT THE INVENTION

Embodiments of the present invention are now described with reference to the accompanying drawings.

It is to be noted that each receiver discussed herein may double as a transmitter, while each transmitter discussed herein may double as a receiver. Each of the receiver and transmitter is not limited to having a signal-receiving or -transmitting capability.

It is also to be noted that MIMO communication discussed herein is of a Multiple-Input/Multiple-Output system, and includes various types of communication to be made through a plurality of antennas.

### First Embodiment

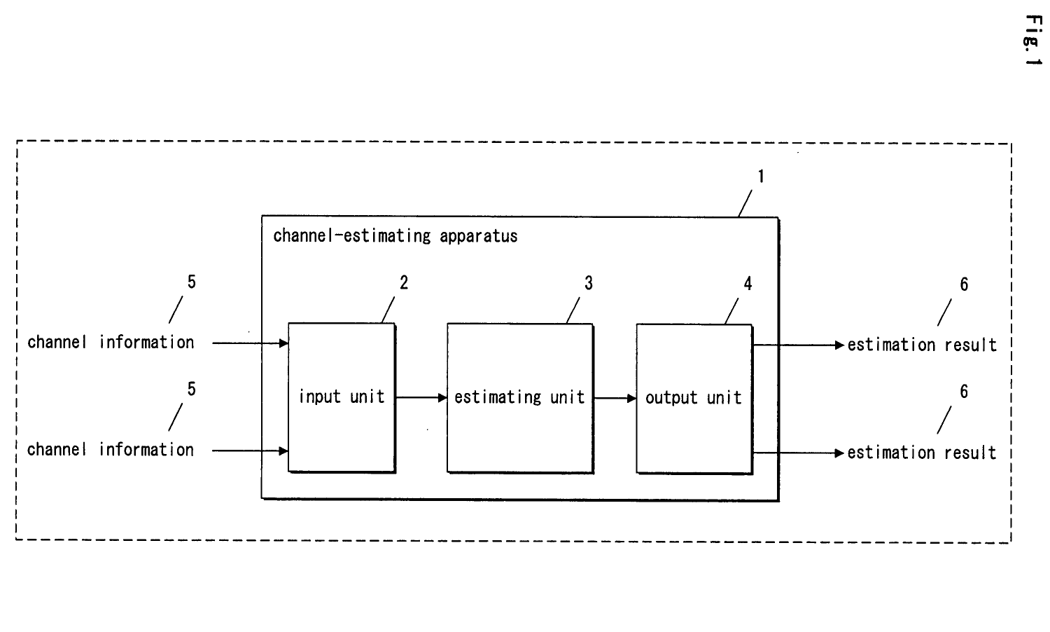

A channel-estimating apparatus according to a first embodiment and a communication system according thereto are now described with reference to FIG. 1 to FIG. 6.

FIG. 1 is a block diagram illustrating the channel-estimating apparatus according to the present embodiment.

The channel-estimating apparatus 1 includes elements as discussed below. An input unit 2 is operable to receive several pieces of channel information 5. The several pieces of channel information 5 are outputted from a plurality of MIMO communication receivers (not shown). An estimating unit 3 is operable to estimate statuses of a plurality of channels in accordance with the several pieces of channel information 5 received by the input unit 2. The plurality of channels is formed by the plurality of MIMO communication receivers (not shown). The estimating unit 3 is operable to generate estimation results, and to feed the generated estimation results into an output unit 4. The output unit 4 is operable to feed the estimation results 6 into the plurality of receivers (not shown).

At this time, the estimating unit 3 collectively estimates the statuses of the plurality of channels. Since the channel-estimating apparatus 1 receives the channel information 5 from the plurality of receivers (not shown), the estimating unit 3 can estimate the statuses of all of the plurality of channels formed by the plurality of receivers (not shown). As a result, the statuses of all of the channels are estimated, even with the presence of contiguous MIMO communication receivers.

Although the estimating unit 3 can estimate the statuses of all of the channels, the estimating unit 3 may alternatively estimate only some of the channels in dependant upon specifications of the channel estimation.

As described above, the statuses of the plurality of channels formed by the plurality of MIMO communication receivers are collectively estimated, whereby MIMO communication operable to suppress interference between the neighboring receivers is achievable.

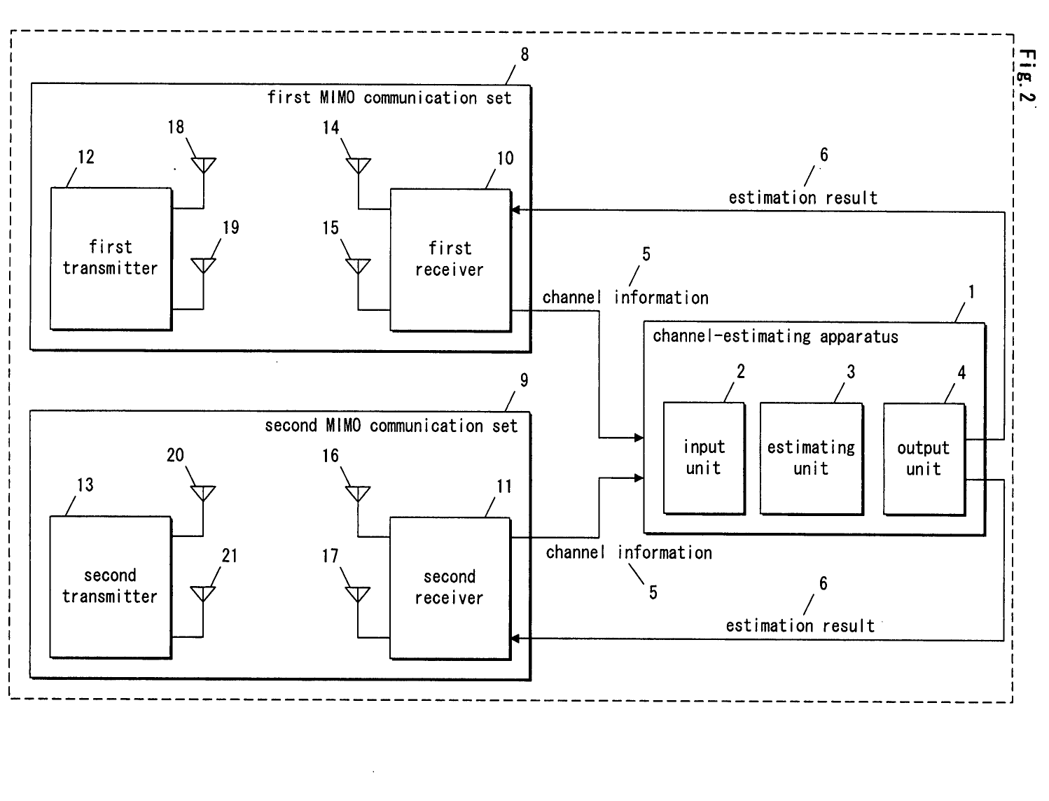

Details of behaviors are described with reference to FIG. 2 to FIG. 5.

FIG. 2 is a block diagram illustrating the communication system according to the present embodiment.

Referring to FIG. 2, two pairs of transmitter and receiver sets, or a pair of MIMO communication sets, are shown positioned adjacent to one another to provide MIMO communication in each of the MIMO communication sets.

A first MIMO communication set 8 includes a first transmitter 12 and a first receiver 10. Similarly, a second MIMO communication set 9 includes a second transmitter 13 and a second receiver 11. More specifically, the pair of MIMO communication sets is arranged adjacent to one another. At this time, the first and second MIMO communication sets 8, 9 are respectively communicating, using the same frequency band.

As a result, signals from the second transmitter 13 are unwanted by the first receiver 10, and can be interference waves. Similarly, signals from the first transmitter 12 are unwanted by the second receiver 11, and can be interference waves.

In the channel-estimating apparatus 1, the input unit 2 receives the channel information 5 from both of the first and second receivers 10, 11.

The estimating unit 3 estimates, in accordance with the channel information 5 received by the input unit 2, statuses of all of a plurality of channels formed by both of the first and second MIMO communication sets 8, 9.

The estimation results 6 provided by the estimating unit 3 is fed therefrom into the first and second receivers 10, 11 through the output unit 4. Since the estimation results 6 contain results from the estimation of all of the channels in the pair of MIMO communication sets, the first and second receivers 10, 11 can adjust the receipt of signals in accordance with the estimation of all of the channels.

For example, a level at which signals are received by each of the antennas on each of the receivers is weighted in an adjustable manner. The estimation results 6 received by the first and second receivers 10, 11 contain results from the estimation of the channels formed by both of the first and second MIMO communication sets 8, 9. Accordingly, the first receiver 10 is possible to appreciate statuses of channels formed between the second transmitter 13 and the first receiver 10 as well, and is consequently possible to reduce signals from the second transmitter 13 before receiving all signals. Similarly, the second receiver 11 is possible to appreciate statuses of channels formed between the first transmitter 12 and the second receiver 11 as well, and is possible to reduce signals from the first transmitter 12 before receiving all signals.

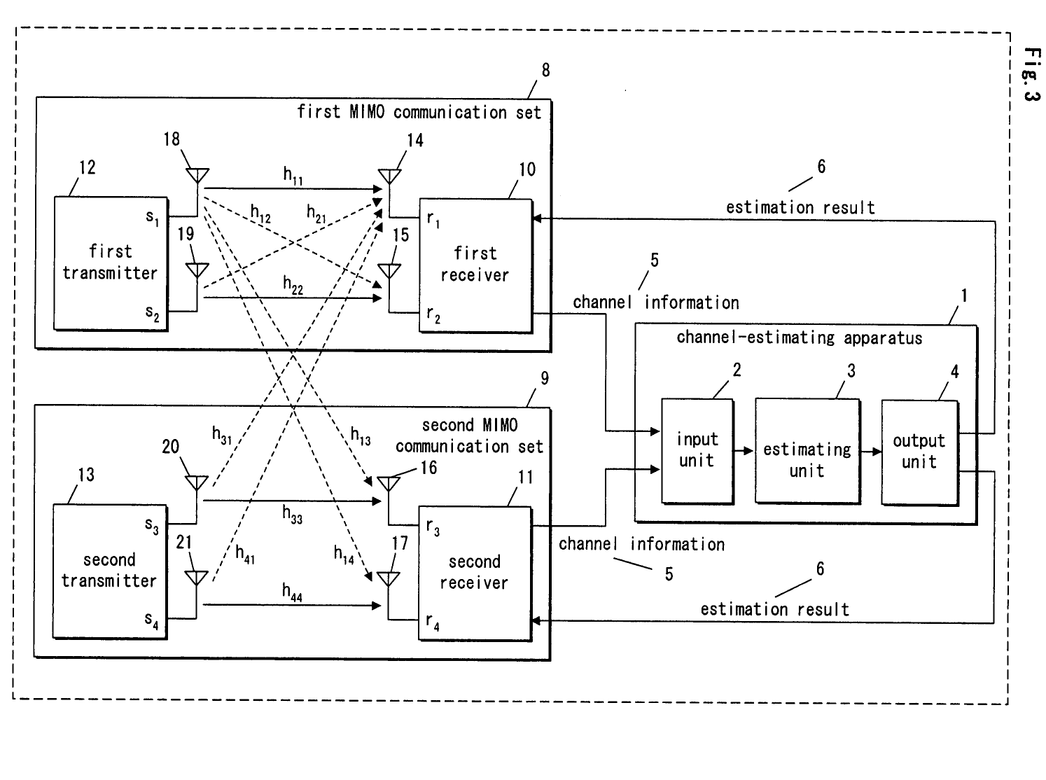

The channel estimation is described in details with reference to FIG. 3.

FIG. 3 is a block diagram illustrating the communication system according to the present embodiment.

The MIMO communication is made between the first transmitter 12 and the first receiver 10 in the first MIMO communication set 8.

Similarly, the MIMO communication is made between the second transmitter 13 and the second receiver 11 in the second MIMO communication set 9.

Each of the first transmitter 12, first receiver 10, second transmitter 13, and second receiver 11 includes a plurality of antennas. The first transmitter 12 includes antennas 18, 19. The first receiver 10 includes antennas 14, 15. The second transmitter 13 includes antennas 20, 21. The second receiver 11 includes antennas 16, 17.

Although each of the receivers and transmitters of FIG. 3 includes two antennas, each of them may alternatively includes three or more antennas.

In each of the MIMO communication sets, the transmitter may has as many antennas as those on the receiver, or otherwise may has either more or fewer antennas than those on the receiver. In each of the MIMO communication sets, as many transmitters as the receivers may be provided, or otherwise either more or fewer transmitters than the receivers may be provided. For example, there may be provided a singular transmitter and plural receivers operable to make MIMO communication with the transmitter.

The MIMO communication is now briefly discussed.

In the MIMO communication, each of the plurality of antennas is operable to transmit narrow band signals. In each of the receivers, each signal received by each of the antennas is weighted at each of the antennas to experience the maximum ratio combining, thereby demodulating the narrow band signals received by all of the antennas. As a result, the increased capacity of communication is attainable.

Alternatively, directivity between the several antennas on the transmitter and receiver may be adjusted, whereby the antennas on the receiver are allowed to receive signals through only target antennas for use in communication.

For example, the antenna 14 on the first receiver 10 communicates with the antenna 18 on the first transmitter 12. The antenna 15 on the first receiver 10 communicates with the antenna 19 on the first transmitter 12. At this time, the directivity between the antennas 18, 14 is adjusted to a maximum extent, while that between the antennas 19, 14 is adjusted to a minimum extent, whereby the antenna 14 is allowed to receive signals from only the antenna 18. Similarly, the directivity between the antennas 15, 18 is adjusted to a minimum degree, while that between the antennas 15, 19 is adjusted to a maximum degree, whereby the antenna 15 is allowed to receive signals from only the antenna 19.

The above processing steps allow each of the antennas to properly receive signals, even with multiplexing communication through the same frequency band using the plurality of antennas. As a result, the higher capacity of communication is realized.

However, as illustrated in FIG. 3, a greater number of channels are present when a pair of different MIMO communication sets is located adjacent to one another. As a result, any one of the antennas receives different signals that travel through such a large number of channels.

In FIG. 3, the antenna 14 on the first receiver 10 receives signals from the antennas 20, 21 on the second transmitter 13 as well as those from the antennas 18, 19 on the first transmitter 12.

As a result, the antenna 14 receives a signal having a transmitted signal “s1” from the antenna 18 multiplied by channel “h11”, a signal having a transmitted signal “s2” from the antenna 19 multiplied by channel “h21”, a signal having a transmitted signal “s3” from the antenna 20 in the other MIMO communication set multiplied by channel “h31”, and a signal having a transmitted signal “s4” from the antenna 21 multiplied by channel “h41”.

More specifically, a received signal “r1” at the antenna 14 is expressed by:

r1=(h11×s1)+(h21×s2)+(h31×s3)+(h41×s4)

Similarly, a received signal “r2” at the antenna 15 is expressed by a combination of a transmitted signal from each of the antennas 18 to 21 multiplied by corresponding one of the channels. The other received signals “r3” and “r4” at the antennas 16 and 17 are similarly expressed, respectively.

The received signals “r1, r2, r3, and r4” are expressed by the following [FORMULA 1]:

$$( \begin{matrix}{r}_{1} \\ {r}_{2} \\ {r}_{3} \\ {r}_{4}\end{matrix} ) = ( \begin{matrix}{h}_{11} & {h}_{21} & {h}_{31} & {h}_{41} \\ {h}_{12} & {h}_{22} & {h}_{32} & {h}_{42} \\ {h}_{13} & {h}_{23} & {h}_{33} & {h}_{44} \\ {h}_{14} & {h}_{24} & {h}_{33} & {h}_{44}\end{matrix} ) ( \begin{matrix}{s}_{1} \\ {s}_{2} \\ {s}_{3} \\ {s}_{4}\end{matrix} ) \qquad [ FORMULA 1 ]$$

Accordingly, when a status of, e.g., the channel “h11” is estimated, then signals are weighted based on results from the estimation, and each of the antennas is thereby allowed to reduce unwanted signals before receiving all signals.

For example, the antenna 14 weights the signals except for the transmitted signal “s1” to reduce those signals except for the transmitted signal “s1” before receiving all of the signals.

The channels such as “h11” are expressed by a determinant as illustrated in [FORMULA 1], which consists of a combination of the transmitted signals “s1” to “s4” and the received signals “r1” to “r4”. Accordingly, the channels such as “h11” are estimated by dividing the received signals “r1” to “r4” by the transmitted signals “s1” to “s4”, respectively. The estimation of the channels such as “h11” is made by the channel-estimating apparatus 1.

The following discusses how the channel-estimating apparatus 1 estimates a status of each of the channels such as “h11”.

The first and second receivers 10, 11 evaluate received electrical power as electrical power information for each of the received signals “r1, r2, r3, and r4”, and the first and second receivers 10, 11 feed the obtained electrical power information into the channel-estimating apparatus 1 as the channel information 5.

The input unit 2 hands over the received channel information 5 into the estimating unit 3.

The estimating unit 3 calculates a status of each of the channels such as “h11” on the basis of the channel information 5. The estimating unit 3 in receipt of the channel information 5 is thereby allowed to recognize values of the received electrical power (electrical power in “r1, r2, r3, and r4”) contained in the channel information 5. The transmitted signals “s1, s2, s3, and s4” contain transmitted electrical power determined by the transmitters, and the transmitted electrical power are known as well. Accordingly, the estimating unit 3 recognizes values of the known transmitted electrical power as well as those of the received electrical power.

Consequently, the received electrical power (electrical power in “r1, r2, r3, and r4”) contained in the channel information 5 and the known transmitted electrical power (electrical power in “s1, s2, s3, and s4”) are applied by the estimating unit 3 to the determinant defined by [FORMULA 1], whereby a status of each of the channels such as “h11” is calculated.

At this time, statuses of all of the channels from “h11” to “h44” are collectively estimated. More specifically, the statuses of all of the channels for use in the MIMO communication are collectively estimated.

As a result, statuses of channels formed across the first and second MIMO communication sets 8, 9 as well as those of separate channels formed in the first and second MIMO communication sets 8, 9 are estimated.

Alternatively, the estimating unit 3 may estimate only part of the channels in dependence upon specifications of the channel estimation.

Alternatively, the channels may be estimated with reference to either electrical voltage or electrical current instead of the electrical power.

The estimating unit 3 feeds results from the calculation into the output unit 4. At this time, the statuses of all of the channels “h11” to “h44” have been calculated.

The output unit 4 feeds the calculation results from the estimating unit 3 as the estimation results 6 into the first and second receivers 10, 11. As a result, the estimation results 6 contain estimate values of all of the channels “h11” to “h44”.

Alternatively, the output unit 4 may feed different estimation results 6 for each of the first and second receivers 10, 11 in dependence upon specifications of the channel estimation, and the estimation results 6 received by the first receiver 10 differ from those received by the second receiver 11.

To receive all signals, the first and second receivers 10, 11 in receipt of the estimation results 6 reduces unwanted signals in accordance with the estimate values of all of the channels “h11” to “h44” from the estimation results 6. For example, each of the first and second receivers 10, 11 changes the antenna directivity in accordance with the channel estimation results 6 to reduce unwanted signal electrical power. The changed antenna directivity adjusts the directivity between the antenna 14 and the transmitter antennas except for the antenna 18 to a minimum extent, whereby the antenna 14 chiefly receives the transmitted signal “s1” from the antenna 18, in which the transmitted signal “s1” is required for the MIMO communication. These processing steps are similarly applied to the other receiver antennas. The directivity adjustment as just discussed above prevents interference between the first and second receivers 10, 11, which otherwise would occur as a result of signals intercommunicated between the first and second receivers 10, 11. As a result, even with the presence of a plurality of contiguous MIMO communication sets, MIMO communication without reductions in both quality and capacity of communication is achievable.

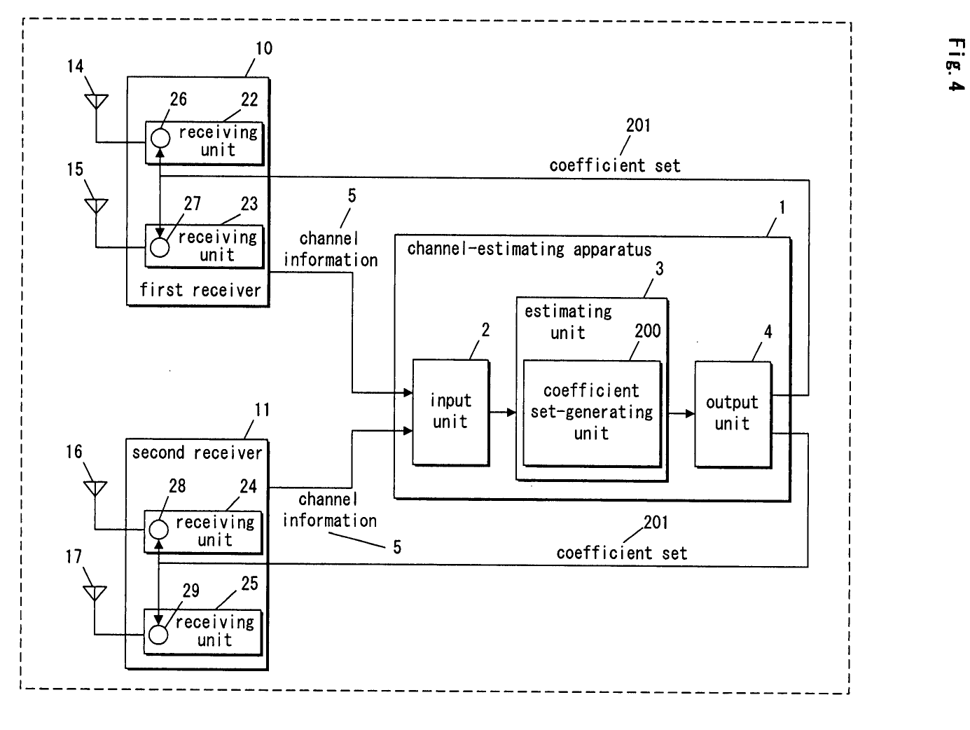

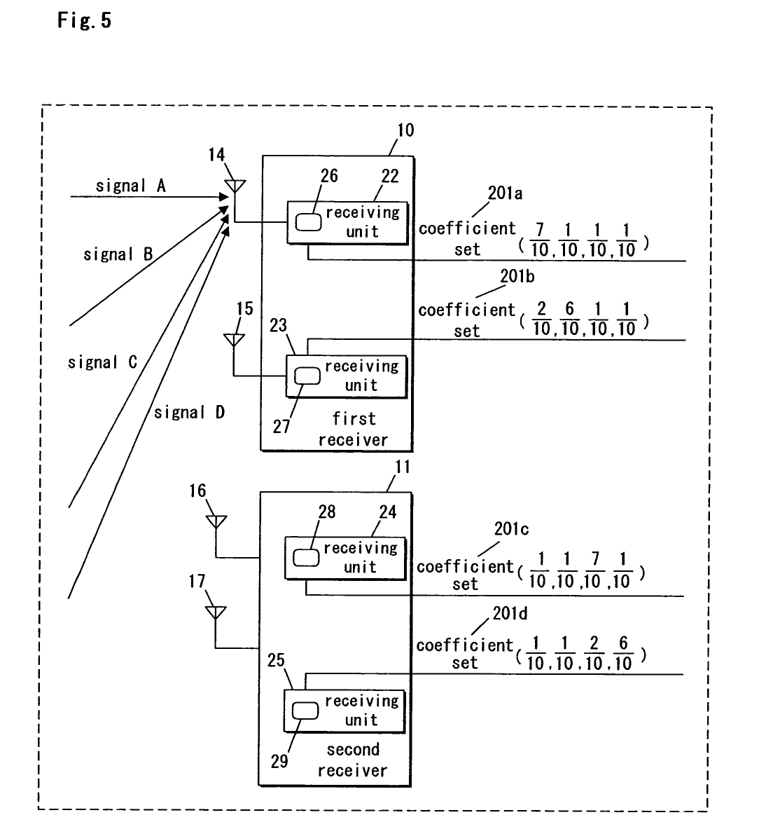

The following discusses, with reference to FIGS. 4 and 5, how the estimation results 6 are associated with weighting coefficients in receiving units connected to the antennas on the receivers.

FIG. 4 is a block diagram illustrating the communication system according to the present embodiment. FIG. 5 is a block diagram illustrating the plurality of receivers according to the present embodiment.

The first receiver 10 includes the antennas 14, 15 and receiving units 22, 23, respectively. The receiving units 22, 23 are operated to receive signals through the antennas 14 and 15, respectively.

The receiving units 22 and 23 possess MIMO communication weighting coefficients 26 and 27, respectively.

Similarly, the second receiver 11 includes the antennas 16, 17 and receiving units 24, 25, respectively. The receiving units 24, 25 are operated to receive signals through the antennas 16 and 17, respectively.

The receiving units 24 and 25 possess MIMO communication weighting coefficients 28 and 29, respectively.

The receiving units 22, 23, 24, and 25 execute the maximum ratio combining of received signals on the basis of the weighting coefficients 26, 27, 28, and 29, respectively. As a result, the receiving units 22, 23, 24, and 25 are possible to receive signals without interference between the first and second receivers 10, 11.

To this end, the estimating unit 3 of FIG. 4 calculates, on the basis of the channel information 5, coefficients corresponding to the weighting coefficients 26 to 29.

The estimating unit 3 includes a coefficient set-generating unit 200.

The coefficient set-generating unit 200 is operable to generate a coefficient set 201, a combination of coefficients corresponding to the weighting coefficients 26 to 29. The coefficient set 201 includes as many coefficients as all antennas (or the four antennas 14 to 17 of FIG. 4) on a plurality of MIMO communication receivers (or the first and second receivers 10, 11 of FIG. 4) because each of the antennas receives signals that travel through as many channels as all of the antennas. Alternatively, the coefficient set 201 may include coefficients different in number from all of the antennas.

The coefficient set 201 generated by the coefficient set-generating unit 200 is outputted therefrom into the first and second receivers 10, 11 through the output unit 4.

In the receiving units 22 to 25, the coefficient set 201 is utilized as the weighting coefficients for signals received by the receiving units 22 to 25. More specifically, the coefficient set 201 is used as the weighting coefficients 26, 27, 28, and 29 in the receiving units 22, 23, 24, and 25, respectively.

The receiving units 22 to 25 receive and weight signals in accordance with the weighting coefficients 26 to 29 determined by the coefficient set 201. Since the coefficient set 201 is generated based on results from the estimation of statuses of the channels, the receiving units 22 to 25 are possible to receive the signals in consideration of the plurality of channels. As a result, the desired signals are receivable with high precision because the receiving units 22 to 25 receive all signals weighted according to the coefficient set 201.

The following discusses, with reference to FIG. 5, the receipt of signals based on the coefficient set 201.

FIG. 5 is a block diagram illustrating part of the communication system according to the present embodiment.

The first receiver 10 includes the antenna 14, the receiving unit 22 connected to the antenna 14, the antenna 15, and the receiving unit 23 connected to the antenna 15. The receiving units 22 and 23 contain the weighting coefficients 26 and 27, respectively.

Similarly, the second receiver 11 includes the antenna 16, the receiving unit 24 connected to the antenna 16, the antenna 17, and the receiving unit 25 connected to the antenna 17. The receiving units 24 and 25 contain the weighting coefficients 28 and 29, respectively.

The weighting coefficients 26, 27, 28, and 29 are updated by the coefficient set 201 received from the channel-estimating apparatus 1. As illustrated in FIG. 5, the weighting coefficient 26 is updated by a coefficient set “201a”, and is thereby used to weight signals received by the receiving unit 22; the weighting coefficient 27 is updated by a coefficient set “201b”, and is thereby used to weight signals received by the receiving unit 23; the weighting coefficient 28 is updated by a coefficient set “201c”, and is thereby used to weight signals received by the receiving unit 24; and the weighting coefficient 29 is updated by a coefficient set “201d”, and is thereby used to weight signals received by the receiving unit 25.

The coefficient set “201a” corresponding to the weighting coefficient 26 includes four different coefficients of 7/10, 1/10, 1/10, and 1/10, and the weighting coefficient 26 updated by the coefficient set “201a” provides values of 7/10, 1/10, 1/10, and 1/10. The receiving unit 22 receives signals “A”, “B”, “C”, and “D” through the antenna 14. The signals “A”, “B”, “C”, and “D” travel through four different channels. The receiving unit 22 multiplies the signals “A”, “B”, “C”, and “D” by the weighting coefficient 26 of 7/10, 1/10, 1/10, and 1/10, respectively.

As a result, the plurality of signals “A”, “B”, “C”, and “D” that have reached the antenna 14 are received and weighted individually. Similarly, the plurality of signals that have reached the remaining antennas 15 to 17 are weighted by the other receiving units 23 to 25, respectively.

Weighting the received signals suppresses unwanted interference between the first and second receivers 10, 11, and MIMO communication accompanied by the higher quality and capacity of communication is achievable.

As described above, the coefficient set 201 in the channel-estimating apparatus 1 is based on the estimation of the plural channels formed in the MIMO communication, and is utilized as the weighting coefficients in the receiving units 22 to 25, whereby MIMO communication operable to suppress unwanted interference between the first and second receivers 10, 11 is attainable.

It is also preferred that the estimating unit 3 estimates the channels based on either an interference canceller system or a maximum likelihood estimate method.

Although FIG. 3 as well as other drawings illustrates the pair of contiguous MIMO communication sets including as many transmitters as the receivers, an alternative MIMO communication set including a singular transmitter and plural receivers is similarly available.

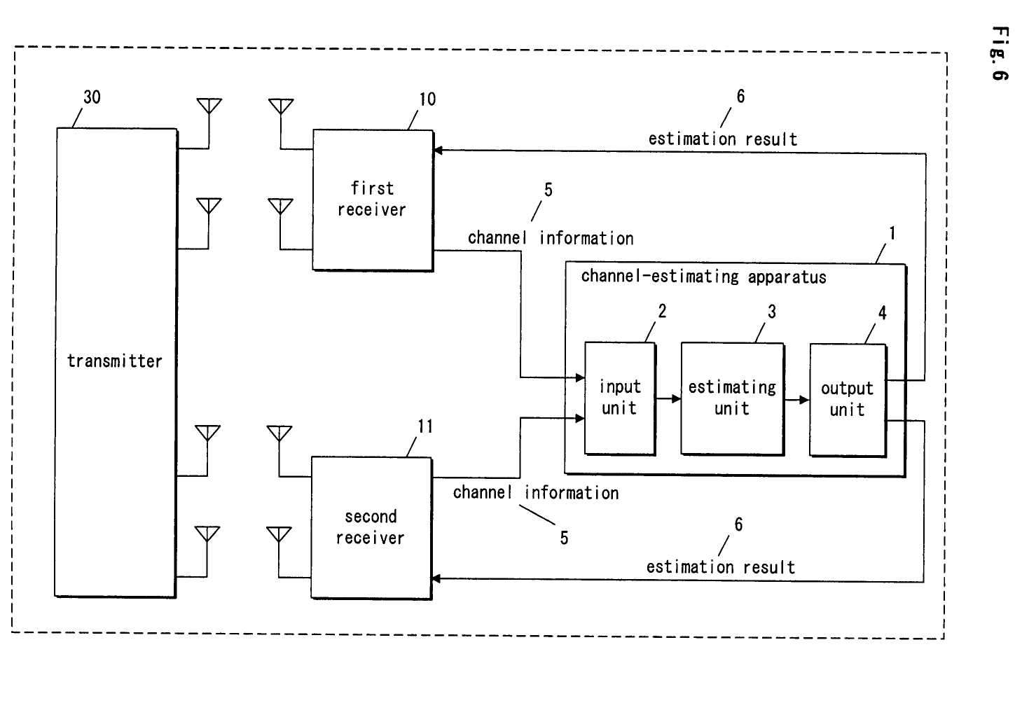

For example, as illustrated in FIG. 6, a MIMO communication set operable to make MIMO communication between one transmitter 30 and two receivers (or first and second receivers 10, 11) is similarly available.

In communication systems including the MIMO communication set of FIG. 6, the channel-estimating apparatus 1 collectively estimates statuses of plural channels formed by each of the first and second receivers 10, 11. The collective estimation of all of the channels provides MIMO communication operable to suppress unwanted interference between the two receivers (the first and second receivers 10, 11).

The input unit 2, estimating unit 3, and output unit 4 may be formed by separate circuits or otherwise the same circuit. At least one of the input unit 2, estimating unit 3, and output unit 4 may be formed by either an IC or LSI. The units structured by the IC or LSI achieve downsizing and less power consumption.

Although the present embodiment discusses the pair of MIMO communication sets, three or more MIMO communication sets may alternatively be available.

The MIMO communication is also available in wireless LAN and in-plant radio transmission. The MIMO communication may be used in diversity communication as well.

The channel-estimating apparatus 1 according to the present embodiment is preferably incorporated into wireless communication equipment or systems accompanied by multiple antennas such as the wireless LAN. The channel-estimating apparatus 1 may be used solely or otherwise may optionally be built into communication systems.

Similarly, the communication system according to the present embodiment is desirably built into various types of wireless communication accompanied by the multiple antennas, or otherwise is preferably applied to different systems combined with other apparatuses and equipment.

### Second Embodiment

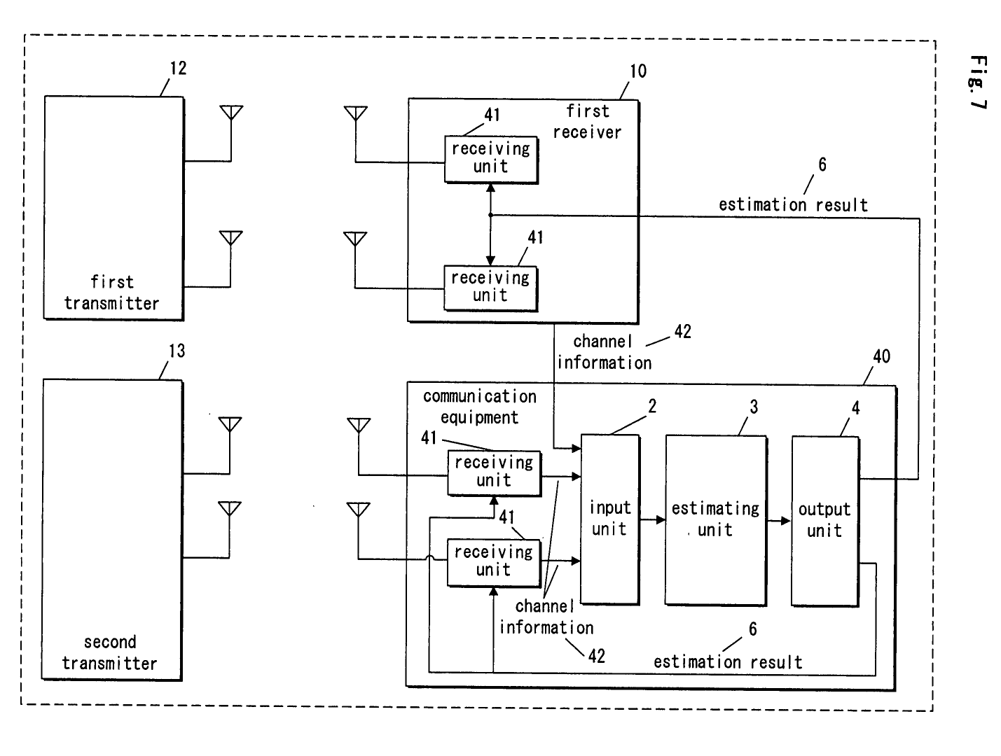

A second embodiment is now described with reference to FIG. 7.

The present embodiment discusses a system in which at least one of MIMO communication-adapted communication apparatuses is provided with a channel-estimating function.

FIG. 7 is a block diagram illustrating a communication system according to the present embodiment.

MIMO communication is made between a first transmitter 12 and a first receiver 10 through a plurality of channels. Each of the first transmitter and receiver 12, includes several antennas. The plurality of channels is formed between the plurality of antennas on both of the first transmitter 12 and the first receiver 10.

MIMO communication is made between a second transmitter 13 and communication equipment 40 through a plurality of channels. Each of the second transmitter 13 and communication equipment 40 includes several antennas. The plurality of channels is formed between the plurality of antennas on both of the second transmitter 13 and the communication equipment 40. The communication equipment 40 serves as a receiver. In FIG. 7, each of the transmitters has a signal-transmitting function, while each of the receivers has a signal-receiving function, and they are called as a transmitter and a receiver, respectively. Alternatively, the transmitter may have additionally a signal-receiving function, while the receiver may have additionally a signal-transmitting function. Although acting as the receiver in FIG. 7, the communication equipment 40 may alternatively have a signal-transmitting function as well, or otherwise may be single-functioned.

The communication equipment 40 with the plurality of antennas and a plurality of receiving units 41 connected to the plurality of antennas includes other elements as discussed below.

An input unit 2 is operable to receive channel information 42 from the plurality of receiving units 41 in the communication equipment 40, and channel information 42 from the first receiver 10. More specifically, the input unit 2 receives the channel information 42 in the communication equipment 40 that includes the input unit 2, as well as the channel information 42 from another receiver (or the first receiver 10 of FIG. 7).

An estimating unit 3 is operable to estimate a status of each channel in accordance with the channel information 42 received by the input unit 2. At this time, statuses of several channels formed between the first transmitter 12 and the communication equipment 40 are collectively estimated. As a result, the estimating unit 3 estimates, e.g., channels formed between the second transmitter 13 and the first receiver 10 as well as those between the first transmitter 12 and the communication equipment 40.

An output unit 4 is operable to output estimation results 6 from the estimating unit 3. At this time, the estimation results 6 are outputted from the output unit 4 into the receiving units 41 in the communication unit 40 that includes the output unit 4, and into receiving units 41 in the first receiver 10.

In each of the first receiver 10 and communication equipment 40, signals are weighted by each of the receiving units 41 in accordance with the received estimation results 6, or otherwise antenna directivity is adjusted based on the received estimation results 6, whereby the signals are optimally received.

For example, the directivity of a pair of antennas for use in MIMO communication is adjusted in accordance with the estimation results 6 to provide maximum directivity, while that of other antennas except for the pair of antennas for use in the MIMO communication is adjusted in accordance therewith to provide minimum directivity. As a result, MIMO communication operable to suppress unwanted interference from another transmitter unrelated to the MIMO communication is provided. Accordingly, MIMO communication with the higher quality and capacity of communication is realized, even with the adjacency of another MIMO communication set.

Alternatively, since the estimation results 6 correspond to a coefficient set that includes coefficients corresponding to the weighting coefficients for use in the receiving units 41, the receiving units 41 may weight received signals in accordance with the coefficient set. The estimation results 6 based on the plurality of channels are reflected to weight the signals, and unwanted interference from another transmitter is avoidable. As a result, MIMO communication operable to suppress unwanted interference from another transmitter unrelated to the MIMO communication is provided. Accordingly, MIMO communication with the higher quality and capacity of communication is realized, even with the adjacency of another MIMO communication set.

As described above, the channel-estimating capability is built into the communication equipment capable of receiving and transmitting signals in the MIMO communication, whereby a communication system characterized by higher-communication quality and higher-transmission capacity is constructed with ease. In particular, the communication equipment incorporating the channel-estimating capability therein facilitates the formation of a higher-flexible communication system.

Each of the input unit 2, estimating unit 3, and output unit 4 may be formed by either separate circuits or the same circuit. Alternatively, at least one of the input unit 2, estimating unit 3, and output unit 4 may be formed by an IC or LSI. The units formed by the IC or LSI provide downsizing and less power consumption.

As a further alternative, units including the receiving units 41 may be formed by the IC or LSI, thereby achieving further downsizing.

Although the present embodiment discusses the pair of MIMO communication sets, three or more MIMO communication sets may be used.

The transmitters may differ in number from the receivers.

The MIMO communication is available in wireless LAN or in-plant radio transmission. The MIMO communication may be used in diversity communication as well.

The communication equipment 40 according to the present embodiment is preferably implemented in communication equipment and modems operable to make wireless communication such as the wireless LAN.

### Third Embodiment

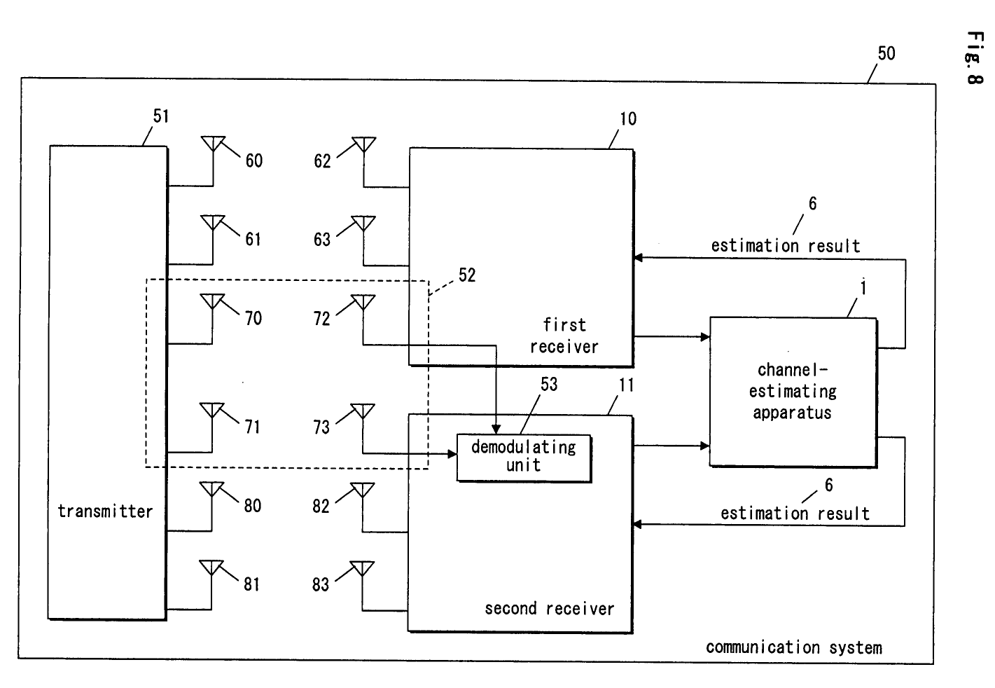

A third embodiment is now described with reference to FIG. 8.

The present embodiment discusses a communication system including MIMO communication sets operable to provide MIMO communication through antennas disposed on two or more receivers among a plurality of receivers.

FIG. 8 is a block diagram illustrating the communication system according to the present embodiment.

The communication system 50 includes a transmitter 51, a first receiver 10, a second receiver 11, and a channel-estimating apparatus 1.

Each of the transmitter 51, first receiver 10, and second receiver 11 includes a plurality of antennas.

MIMO communication is made between the transmitter 51 and the first receiver 10 through antennas 60, 61 on the transmitter 51, and antennas 62, 63 on the first receiver 10.

MIMO communication is made between the transmitter 51 and the second receiver 11 through antennas 80, 81 on the transmitter 51, and antennas 82, 83 on the second receiver 11.

Antennas 70, 71 on the transmitter 51, an antenna 72 on the first receiver 10, and an antenna 73 on the second receiver 11 are unused.

Pursuant to the present embodiment, the unused antennas are operatively utilized to provide the MIMO communication therebetween. A MIMO communication set 52 is operable to provide the MIMO communication therein through the antennas 70, 71, 72, and 73. More specifically, signals are sends out from the antennas 70, 71 on the transmitter 51 to both of the antenna 72 on the first receiver 10 and the antenna 73 on the second receiver 11.

The antennas 72, 73 are disposed on the different receivers or rather the first and second receivers 10, 11 of FIG. 8, respectively. As a result, a demodulating unit 53 receives signals through both of the antennas 72, 73. At this time, the first receiver 10 feeds the signals received by the antenna 72 into the demodulating unit 53.

The demodulating unit 53 may be provided in either the second receiver 11 or the first receiver 10. It is preferred that the first and second receivers 10, 11 negotiate with one another to determine whether the unused antennas are shared by them, before the MIMO communication set 52 is formed.

As described above, the signals received by the antennas disposed on the different receivers are received by the demodulating unit 53, whereby the unused antennas are operatively usable.

In particular, there sometimes occur unused antennas in the MIMO communication accompanied by several antennas, and antennas on another receiver are shared to form a new MIMO communication set, whereby the unused antennas are operatively used.

While the antennas disposed on the two or more receivers are used to form the MIMO communication set(s), the channel-estimating apparatus 1 is allowed to estimate a plurality of formed channels, and signals are receivable in a state in which interference from other antennas is suppressed.

More specifically, even with the presence of a plurality of contiguous MIMO communication sets, the channel-estimating apparatus 1 operable to collectively estimate a plurality of channels formed between the transmitter and the receivers suppresses unwanted interference among the plurality of contiguous MIMO communication sets, whereby MIMO communication characterized by higher-communication quality and higher-communication capacity is available. In particular, when unused antennas are operatively utilized to form a MIMO communication set, a plurality of MIMO communication sets are always arranged in proximity to each other, thereby causing a problem of unwanted mutual interference among the plurality of contiguous MIMO communication sets; however, the channel-estimating apparatus 1 operable to collectively estimate a plurality of channels is operated to overcome the aforesaid problem.

As a result, the MIMO communication accompanied by the higher quality and capacity of communication is provided, while the unused antennas are operatively utilized.

Although the MIMO communication set having the unused antennas disposed on the two different receivers (or rather the first and second receivers 10, 11) is shown formed in FIG. 8, alternative MIMO communication sets having unused antennas disposed on three or more receivers may be formed.

Alternatively, two or more transmitters may be used.

The present invention provides the MIMO communication having the higher quality and capacity of communication, in which unwanted mutual interference among a plurality of contiguous MIMO communication sets is suppressed.

In particular, a plurality of contiguous receivers in the MIMO communication sets using the same frequency band is operable to receive, in dependence upon a status of each channel, unwanted electrical waves that have reached the plurality of receivers, whereby the desired signals are properly receivable without allowing the unwanted electrical waves to be rendered as interference waves.

In addition, the channel-estimating apparatus operable to collectively estimate a plurality of channels suppresses unwanted interference among all of the receivers. As a result, the MIMO communication having the higher quality and capacity of communication is achievable, even when lots of MIMO communication equipment is installed in a small space such as a household.

Moreover, communication equipment provided with a channel-estimating capability is incorporated into part of the MIMO communication set, thereby constructing a highly flexible communication system with ease.

Furthermore, a plurality of channels is collectively estimated by the channel-estimating apparatus, whereby a MIMO communication set that operatively utilizes unused antennas present on two or more receivers is formed without the occurrence of unwanted interference between the receivers.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

### INDUSTRIAL APPLICABILITY

The present invention is preferably applicable in MIMO communication-adapted communication equipment or systems such as, e.g., wireless LAN using multiple antennas and line-multiplexing system-based wireless modems using multiple antennas.

1. A channel-estimating apparatus comprising:
an input unit operable to receive several pieces of channel information from a plurality of receivers, said plurality of receivers being operable to perform MIMO communication through a plurality of channels;
an estimating unit operable to collectively estimate statuses of the plurality of channels in accordance with the several pieces of channel information received by said input unit, whereby estimation results are generated; and
an output unit operable to feed the estimation results into said plurality of receivers.

2. A channel-estimating apparatus as defined in claim 1, wherein each of said plurality of receivers comprises a plurality of antennas and a plurality of receiving units, each of said plurality of receiving units being connected to corresponding one of said plurality of antennas, and wherein each of the several pieces of channel information is received electrical power of a signal received by each of said plurality of receiving units.

3. A channel-estimating apparatus as defined in claim 2, wherein said estimating unit divides the received electrical power by each predetermined electrical power value, thereby generating the estimation results.

4. A channel-estimating apparatus as defined in claim 1, wherein said estimating unit generates the estimation results for all of the plurality of channels.

5. A channel-estimating apparatus as defined in claim 4, wherein the estimation results are a combination of as many pieces of estimation results as the plurality of channels.

6. A channel-estimating apparatus as defined in claim 2, wherein each of said plurality of receiving units possesses weighting coefficients for use in weighting the received electrical power, and wherein said estimating unit generates coefficients as the estimation results, the coefficients being corresponding to the weighting coefficients.

7. A channel-estimating apparatus as defined in claim 6, wherein said output unit feeds a coefficient set into said plurality of receivers, the coefficient set including the coefficients.

8. A channel-estimating apparatus as defined in claim 7, wherein the coefficients in the coefficient set correspond in number to all of said plurality of antennas possessed by said plurality of receivers.

9. MIMO communication-adapted communication equipment, comprising:
an input unit operable to receive several pieces of channel information from a plurality of receivers, said plurality of receivers being operable to perform MIMO communication through a plurality of channels;
an estimating unit operable to collectively estimate statuses of the plurality of channels in accordance with the several pieces of channel information received by said input unit, whereby estimation results are generated; and
an output unit operable to feed the estimation results into said plurality of receivers.

10. A communication system comprising:
a plurality of receivers operable to provide MIMO communication through a plurality of channels; and
a channel-estimating apparatus operable to estimate statuses of the plurality of channels,
wherein said channel-estimating apparatus includes:
an input unit operable to receive several pieces of channel information from said plurality of receivers;
an estimating unit operable to collectively estimate statuses of the plurality of channels in accordance with the several pieces of channel information received by said input unit, whereby estimation results are generated; and
an output unit operable to feed the estimation results into said plurality of receivers.

11. A communication system as defined in claim 10, wherein each of said plurality of receivers includes a plurality of antennas and a plurality of receiving units, each of said plurality of receiving units being connected to corresponding one of said plurality of antennas, and wherein each of the several pieces of channel information is received electrical power of a signal received by each of said plurality of receiving units.

12. A communication system as defined in claim 11, wherein said estimating unit divides the received electrical power by each predetermined electrical power value, thereby generating the estimation results.

13. A communication system as defined in claim 10, wherein said estimating unit generates the estimation results for all of the plurality of channels.

14. A communication system as defined in claim 13, wherein the estimation results are a combination of as many pieces of estimation results as the plurality of channels.

15. A communication system as defined in claim 11, wherein each of said plurality of receiving units possesses weighting coefficients for use in weighting the received electrical power, and wherein said estimating unit generates coefficients as the estimation results, the coefficients being corresponding to the weighting coefficients.

16. A communication system as defined in claim 15, wherein said output unit feeds a coefficient set into said plurality of receivers, the coefficient set including the coefficients.

17. A communication system as defined in claim 16, wherein the coefficients in the coefficient set correspond in number to all of said plurality of antennas possessed by said plurality of receivers.

18. A communication system as defined in claim 10, wherein the MIMO communication is made through antennas possessed by at least two receivers among said plurality of receivers.
